(19) United States
(12) Patent Application Publication
(10) Pub. No.: US 2005/0109111 A1
(43) Pub. Date: May 26, 2005

(54) Sensor and method of transmitting sensor data

(75) Inventors: Gregory J. Manlove, Kokomo, IN (US); Robert K. Constable, Kokomo, IN (US); Hamid R. Borzabadi, Noblesville, IN (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., TROY, MI (US)

(21) Appl. No.: 10/697,550

(22) Filed: Oct. 30, 2003

(51) Int. Cl. G01C 17/38

(52) U.S. Cl. 73/583

(57) ABSTRACT

A sensor and method are provided for transmitting sensor generated output signals in a pulse width modulated output signal. The sensor includes a pressure sensing element for sensing pressure and temperature sensing circuitry for sensing temperature. Output circuitry outputs a pulse width modulated signal containing an indication of the pressure and temperature. The pressure is transmitted as a function of duty cycle of the pulse width modulated output signal, and the temperature is transmitted as a function of frequency of the pulse width modulated output signal.

### TECHNICAL FIELD

The present invention generally relates to sensors and, more particularly, relates to a sensor, such as a pressure sensor, and method for transmitting multiple sensed characteristics in a pulse width modulated signal.

### BACKGROUND OF THE INVENTION

Pressure sensors and various other sensors are commonly employed in automotive vehicle applications to control and monitor various aspects of the vehicle operation. In particular, pressure sensors are commonly employed in passive occupant detection systems (PODS) which typically employ a fluid-filled bladder connected to the pressure sensor, a belt tension sensor, and an electronic control unit (ECU). The pressure sensor employed in a conventional PODS generally has a three-wire interface, providing supply, ground, and an output voltage. The output voltage generated with the conventional PODS pressure sensor is an analog signal typically operable to sense pressure in the range of about 0 to 2.5 pounds per square inch (psi).

Pressure sensors are generally required to provide an accurate analog voltage output representative of the pressure applied to a sensing element. In automotive applications, the pressure sensor is generally required to be accurate over a large temperature range of approximately −40° to +125° C. throughout the life of the vehicle. In order to compensate for temperature induced variations in the sensor signal, the pressure sensor is equipped with compensation circuitry for compensating for gain and offset due to temperature variations.

In the conventional PODS, the ECU generally include power conditioning circuitry for the pressure sensor and the belt tension sensor, a microprocessor that processes a classification algorithm, and a temperature sensor (thermistor) for temperature compensation of other system components. Additionally, the ECU typically includes serial communication circuitry to communicate passenger occupancy status to a sensing and diagnostic module. The pressure sensor also contains temperature compensation circuitry to correct the gain and offset due to temperature variations. The employment of multiple temperature sensors introduces redundancy and costs to an automotive vehicle. Additionally, the temperature sensors generally require additional electrical circuitry and/or pin configurations to receive the temperature information.

Accordingly, it is therefore desirable to provide for a sensor, such as a pressure sensor, that allows for easy compensation of gain and offset due to temperature variations. In particular, it is desirable to provide for a method of transmitting sensor data, such as pressure and temperature data, to control circuitry in a manner that minimizes circuitry and pin connections.

### SUMMARY OF THE INVENTION

In accordance with the teachings of the present invention, a sensor and method are provided for transmitting sensor generated output signals in a pulse width modulated output signal. According to one aspect of the present invention, the sensor includes a sensing element for sensing a sensor characteristic and temperature sensing circuitry for sensing a temperature characteristics. The sensor also includes output circuitry for outputting a pulse width modulated signal containing an indication of the sensor characteristic and the temperature characteristic. One of the sensor and temperature characteristics is transmitted as a function of pulse width, such as a duty cycle, of the pulse width modulated signal, and the other of the sensor signal and temperature characteristics is transmitted as a function of frequency of the pulse width modulated output signal.

According to another aspect of the present invention, the sensor includes a first sensing element for sensing a first characteristic and a second sensing element for sensing a second characteristic. The sensor also includes output circuitry for generating a pulse width modulated output signal containing the first and second characteristics. The first characteristic is transmitted as a function of pulse width, such as a duty cycle, of the pulse width modulated output signal, and the second characteristic is transmitted as a function of frequency of the pulse width modulated output signal.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram illustrating a passive occupant detection system (PODS) employing an analog pressure sensor communicating pressure and temperature characteristics according to the present invention;

FIG. 2 is a circuit diagram illustrating the analog pressure sensor;

FIG. 3 is a circuit diagram illustrating a VRAMP generator used for generating a pulse width modulated out signal in the sensor;

FIG. 4 is a circuit diagram illustrating a current sourcing circuit for use in the V_{RAMP} generator circuit;

FIG. 5 is a graph illustrating a pulse width modulated output signal generated with the sensor according to the present invention; and

FIG. 6 is a graph illustrating a portion of the variable frequency with temperature ramp voltage V_{RAMP} shown in FIG. 5.

### DESCRIPTION OF THE PREFERRED EMBODIMENT

A sensor is shown and described herein as a pressure sensor, according to one embodiment, for sensing pressure in a passenger occupant detection system (PODS). The sensor further transmits the sensed pressure characteristic and a temperature characteristic in a pulse width modulated output signal. The sensor transmits two characteristics, namely pressure and temperature, in a single pulse width modulated output signal. This is achieved, in the embodiment shown, by transmitting the pressure characteristic as a function of pulse width, such as the duty cycle, of the pulse width modulated output signal, and simultaneously transmitting the temperature characteristic as a function of frequency of the pulse width modulated output signal. While temperature and pressure are shown and described herein for transmitting in the pulse width modulated output signal, it should be appreciated that any two sensor characteristics may be transmitted in the pulse width modulated output signal according to the present invention. The sensor shown and described herein is not intended to be limited to the specific embodiment shown.

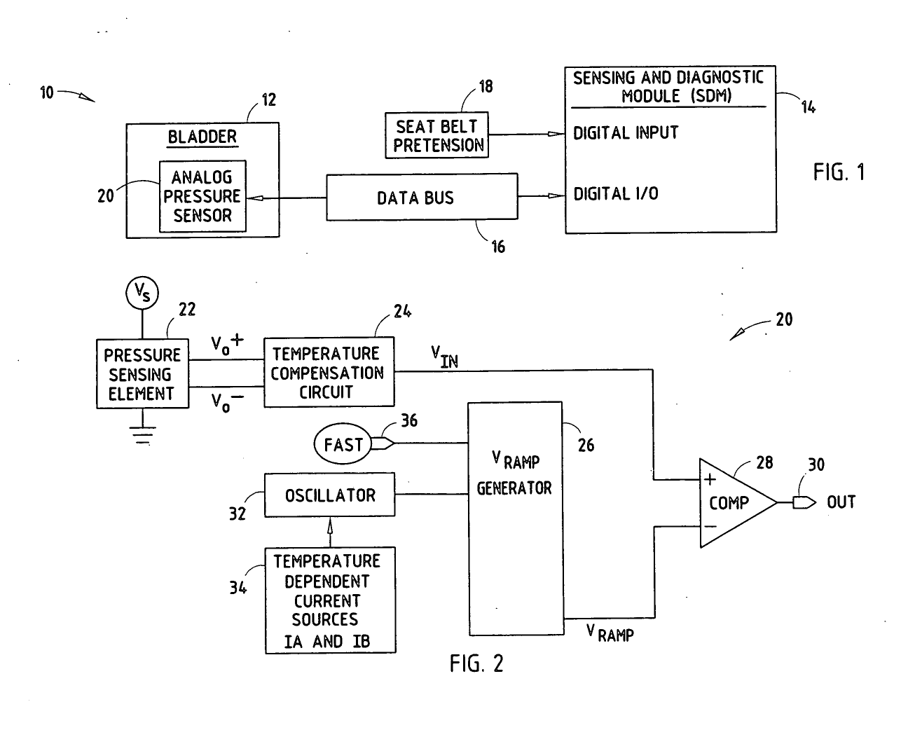

Referring to FIG. 1, a passenger occupant detection system PODS) 10 is generally shown including a fluid-filled bladder 12 of a conventional type, such as may be employed in the seat of an automotive passenger vehicle to detect an occupant in the vehicle seat. An analog pressure sensor 20 is employed for sensing pressure of the fluid-filled bladder 12. The analog pressure sensor 20 may employ any of a number of pressure sensing elements such as piezo-resistive elements and variable capacitance type sensors.

The PODS 10 also includes a sensing and diagnostic module (SDM) 14 for performing sensing, diagnostics, and other processing of the PODS 10 including receipt and processing of the output signal generated by the analog pressure sensor 20. A data bus 16 is provided for communicating data between the analog pressure sensor 20 and the sensing and diagnostic module 14. The data communicated on data bus 16 includes the pressure and temperature characteristics transmitted via a pulse width modulated signal as described herein. One example of the data bus 16 includes a two-wire current modulated data bus. However, other single or multiple wire data buses may be employed.

The sensing and diagnostic module 14 also receives a seat belt pretension signal 18. The seat belt pretension signal 18 is generated with a seat belt pretensioner sensor and is indicative of the pretensioning condition of the seat belt.

Referring to FIG. 2, the analog pressure sensor 20 is shown including a pressure sensing element 22 coupled to a supply voltage V_{S} and ground. The pressure sensing element 22 may include a piezo-resistive sensor having four resistors configured in a Wheatestone Bridge, according to one example, in which the resistors change in proportion to applied pressure to generate a differential output voltage V_{O}+minus V_{O}−. The differential output voltage V_{O}+minus V_{O}− is supplied to a temperature compensation circuit 24 which may include a separate integrated circuit (IC) or may be integrated with the pressure sensing element 22 or other circuitry.

The temperature compensation circuit 24 may include a conventional compensation circuitry for compensating for sensor offsets at room temperature and temperature dependent sensor offsets. This may be achieved by controlling one or more current sources via a programmed function, such as a lookup table. The one or more current sources generate an electrical current that is dependent upon the temperature of the environment. Additionally, the temperature compensation circuit 24 may include a voltage-to-current converter for converting the differential voltage to a current signal, and a multiplier for compensating for room temperature and temperature dependent gain. The temperature compensation circuit 24 generates an analog voltage V_{IN} indicative of the gain and offset compensated pressure. The voltage V_{IN} is applied to a non-inverting input of comparator 28.

The analog pressure sensor 20 also includes a ramp voltage V_{RAMP} generator 26 for generating a ramp voltage signal V_{RAMP}. The ramp voltage V_{RAMP} is applied to the inverting input (−) of comparator 28. The V_{RAMP} generator generates the ramp voltage V_{RAMP} in response to an input from an oscillator 32. The oscillator 32 generates an oscillation signal as a function of temperature via temperature dependent current sources I_{A} and I_{B}. Accordingly, the oscillator 32 generates a ramp voltage V_{RAMP} having a frequency that is dependent on temperature.

The comparator 28 compares the analog voltage V_{IN} to the ramp voltage V_{RAMP} and generates an output signal OUT at output 30. The output signal OUT is a pulse width modulated output signal that transmits (communicates) the sensed pressure characteristic as a function of the pulse width, and more particularly as a function of the duty cycle, of the pulse width modulated output signal. Additionally, the output signal OUT transmits the sensed temperature characteristic as a function of the frequency of the pulse width modulated output signal. Accordingly, both pressure and temperature characteristics are transmitted in a single pulse width modulated output signal. The duty cycle of the pulse width modulated output signal is defined as the pulse width of the signal divided by the period of the signal. With the temperature characteristic transmitted as a function of frequency of the output signal, the pressure characteristic in the duty cycle is unaffected since it is a ratio of the pulse width to the period.

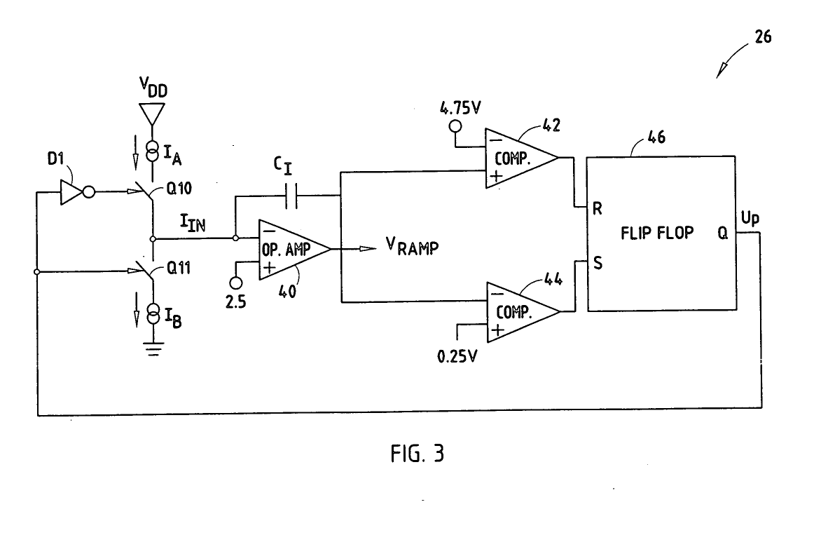

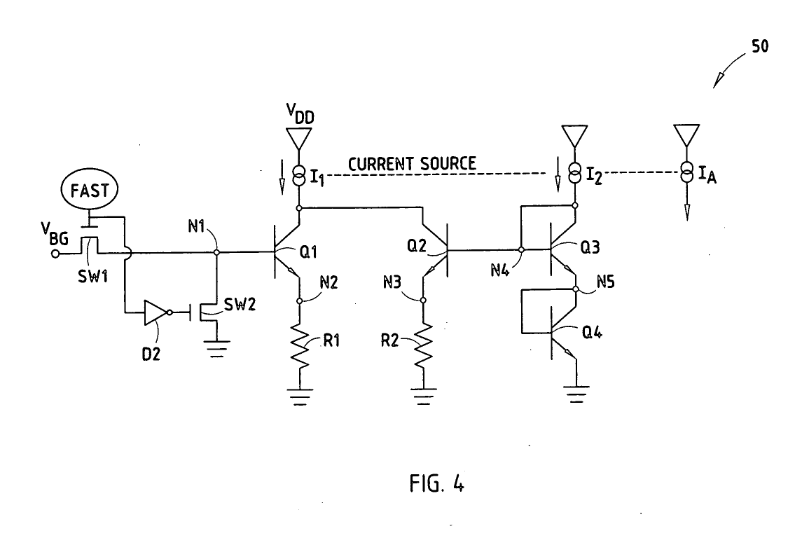

Referring to FIG. 3, the V_{RAMP} generator 26 is illustrated in a circuit diagram having a first current source I_{A} coupled to the voltage supply V_{DD}, and also having a second current source I_{B} coupled to ground. The first and second current sources I_{A} and I_{B} generate electrical current as a function of the environmental temperature, and hence operate as temperature sensing circuitry. While current sources I_{A} and I_{B} are shown configured coupled to a supply voltage V_{DD} and ground, it should be appreciated that other temperature sensing circuitry may be employed to sense temperature, without departing from the teachings of the present invention.

The V_{RAMP} generator 26 includes a pair of transistors Q10 and Q11 coupled between current sources I_{A} and 1_{B}. The junction between transistors Q10 and Q11 is coupled to an inverting input (−) of an op amp 40. The non-inverting input (+) of op amp 40 is coupled to a voltage supply of 2.5 volts. A capacitor C₁ is coupled across op amp 40. The op amp 40 generates the ramp voltage V_{RAMP} as its output.

Additionally, the V_{RAMP} generator 26 includes a pair of comparators 42 and 44 and a flip-flop 46. The first comparator 42 compares the ramp voltage V_{RAMP} to an upper voltage of about 4.75 volts, while the second comparator compares the ramp voltage V_{RAMP} to a lower voltage of about 0.25 volts. The outputs of comparators 42 and 44 are supplied to inputs reset R and set S, respectively, of RS flip-flop 46. Flip-flop 46 generates, at its output Q, a binary an output signal UP which in turn is applied to control transistors Q10 and Q11.

The V_{RAMP} generator 26 operates as follows. Initially, assuming the ramp voltage V_{RAMP} is low, the flip-flop output labeled UP is asserted and the second current source I_{B} is switched into the inverting (−) input terminal of op amp 40. The inverting (−) terminal is a virtual ground and all of the current is applied to capacitor C₁. The ramp voltage V_{RAMP} begins to rise at a frequency (f) defined by the following equation:

$$frequency ( f ) = \frac{I}{C \times ( Δ V )} ,$$

where I equals the input current I_{B}, C is the integrator capacitor C₁, and ΔV is the voltage range of the comparator voltage 4.75 volts minus 0.25 volts, which equals 4.5 volts. The ramp voltage V_{RAMP} continues to increase in magnitude until it is greater than 4.75 volts and, at that point, the output of the first comparator 42 is asserted and the reset input R to the RS flip-flop 46 is asserted and its output Q goes low. This, in turn, turns off the second current source I_{B} and turns on the first current source I_{A}. The first current source I_{A} equals the second current source I_{B} and causes the integrator to ramp down at the same frequency set forth in the above equation. The ramp voltage V_{RAMP} continues to ramp down until its voltage is less than 0.25 volts. At that time, the second comparator 44 is asserted and the set input S on RS flip-flop 46 is asserted such that its output Q causes signal UP to be high, thereby starting the process again.

It should be appreciated that the ramp voltage V_{RAMP} continues to oscillate at the frequency described in accordance with the above equation. The frequency is directly proportional to the first and second current sources I_{A} and I_{B}, which are set equal to one another, according to the embodiment shown herein.

Referring to FIG. 4, the first current source I_{A} is shown generated by a current mirror 50 coupled to a voltage supply V_{DD}. Current mirror 50 generates a negative temperature coefficient (TC) current source that is achieved with transistors Q2, Q3, Q4, and resistor R2. The voltage at node N3 is equal to voltage V_{be} on an NPN transistor (V_{be3}+V_{be4}−V_{be2}) where V_{be2} and V_{be3} are essentially equal because the current through the collectors are essentially the same. Voltage V_{be} has a negative temperature dependency of approximately 2 millivolts per degree Celsius, according to one embodiment. The resistor R2 has a positive temperature coefficient of 1,500 ppm. The reduction in voltage and increase in resistance combine to generate a current that reduces with temperature in a consistent manner such that the current source I_{A} is generated as a function of the temperature, and thus varies as a function of temperature.

The output of the current source is equal to current I₁ and is applied as a current mirror to generate current I₂ and current source I_{A}. Current source I_{A} is the current used in the V_{RAMP} generator circuit 26. An additional current mirror is used to generate the second current source I_{B}, such that current sources I_{A} and I_{B} are the same. The second current source I_{B} is generated similar to the first current source I_{A}, except the second current source I_{B} is coupled to ground, rather than the supply voltage.

The current mirror 50 includes switches SW1 and SW2 and a digital control signal labeled FAST to generate a constant current regardless of temperature. The fast signal is used to produce a desired output frequency that is constant at startup and, thereafter, proportional to temperature following the startup mode. During startup, the FAST signal is asserted, and switch SW1 is switched on and switch SW2 is switched off. The voltage at node N1 moves from ground to voltage V_{bg}. Voltage V_{bg} is the band gap voltage and is approximately equal to 1.25 volts, according to one example. The band gap voltage V_{bg} is generated in an on-chip regulator circuit, according to one embodiment. The voltage at node N2 is equal to voltage V_{bg} minus V_{be1}. Because V_{b3} has a minus two (−2) millivolt per degree Celsius (−2 mV/° C.) slope, the voltage on node N2 increases at a rate of two millivolt per degree Celsius (2 mV/° C.), thus producing a positive temperature coefficient (TC) current source. The collectors of transistors Q1 and Q2 are connected together and are applied to current mirror I₁. The resistor R1 and R2 are established such that the resultant current source I₁, equal to the sum of the negative and positive temperature coefficient current sources, has a zero temperature coefficient output. This generates a current that does not change with temperature.

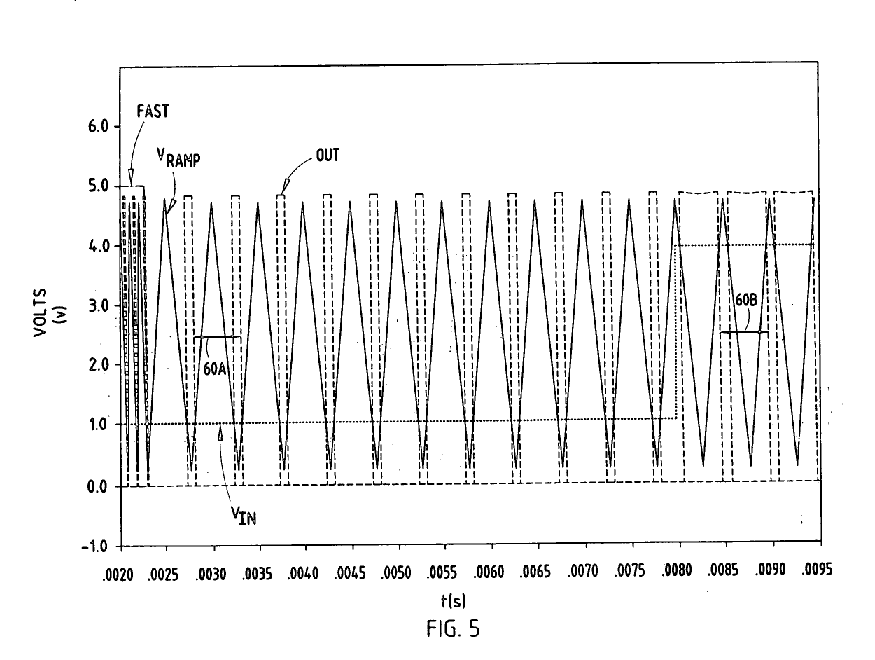

The output of ramp voltage V_{RAMP} is a triangular waveform with a fifty percent (50%) duty cycle that is controlled by the current sources I_{A} and I_{B}, as shown in FIG. 5. When the FAST input is asserted during startup, as shown at the beginning of the waveform seen in FIG. 5, the current source has zero temperature coefficient and the output frequency is constant. During this period of time, a conventional universal asynchronous receiver transmitter (UART) is used for communication during this startup mode, and various types of parameters can be set. For a UART or any other conventional bus, an accurate known frequency is required. In the present application employing UART, the known frequency is 9.6 kHz and is available the first 500 mSec after power up, according to one example.

When the FAST input is deasserted, the current source has a known negative temperature coefficient producing a frequency that is inversely proportional to temperature. The resultant output labeled OUT is a pulse width modulated output signal having its duty cycle determined by the pressure output signal V_{IN}. As the pressure sensed output V_{IN} changes, the duty cycle of PWM signal OUT likewise changes.

In the example illustrated in FIG. 5, the analog sensed output V_{IN} generated by the sensing element is initially at 1.0 volt. The analog voltage V_{IN} is then increased to 4.0 volts at about 8 milliseconds. The duty cycle of the pulse width modulated output signal OUT increases for every change in analog voltage V_{IN}. The pulse width modulated output signal OUT can then be processed to monitor for variations, regardless of any timing uncertainty of a microprocessor. The faster the clock, the more accurate the evaluation of the duty cycle and frequency. Thus, the resolution of the sensor and its transmitted signal is controlled by clock rate of the microprocessor in a receiving device that processes that pulse width modulated output signal OUT.

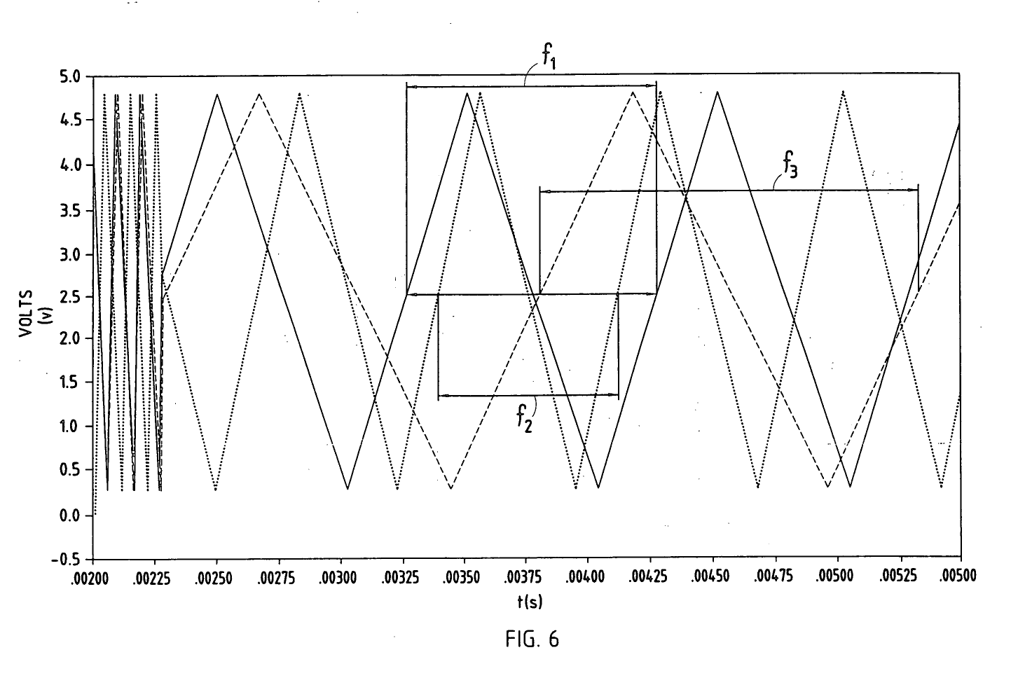

Referring to FIG. 6, the ramp voltage V_{RAMP} is illustrated in a simulation at three different temperature, such as 90° C., 25° C., and −40° C., according to one example. The ramp voltage V_{RAMP} for each temperature is shown simulated to show that the frequencies f3, f1, and f2, of the corresponding signals, exhibit a large temperature dependency. When the integrated circuit is at a temperature of 90° C., the ramp voltage V_{RAMP} has a frequency of approximately 659 Hz. At room temperature, the ramp voltage V_{RAMP} has a frequency of approximately 990 Hz. At a temperature of −40° C., the ramp voltage V_{RAMP} has a frequency of approximately 1371 Hz. This produces a temperature dependent frequency for transmitting the temperature characteristic in the pulse width modulated output signal according to the present invention. In addition, all the clock frequencies are 9.6 kHz, regardless of temperature at startup. This is caused by asserting the FAST signal. During this time, communication of other parameters can take place such as threshold data, vehicle make and model year, security data, etc.

Accordingly, the sensor pressure and temperature characteristics are advantageously transmitted simultaneously in a pulse width modulated output signal without requiring large amounts of additionally circuitry and connecting pins. This advantageously eliminates the need for a separate temperature sensor, such as may be found in the electronic control unit of a passenger occupant detection system, thus resulting in cost savings. Additionally, the resolution of the data is determined by the clock rate of a microprocessor in the passenger occupant detection system electronic control unit. Higher clock rates correlate to more resolution. This allows for enhanced system performance without a modification to the passenger occupant detection system unit, since microprocessors generally have a timer control system, and thus, the circuit interface does not require specialized circuitry.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A sensor comprising:
a sensing element for sensing a sensor characteristic;
temperature sensing circuitry for sensing a temperature characteristic; and
output circuitry for outputting a pulse width modulated output signal containing an indication of the sensor characteristic, wherein one of the sensor and temperature characteristics is transmitted as a function of pulse width of the pulse width modulated output signal, and the other of the sensor and temperature characteristics is transmitted as a function of frequency of the pulse width modulated output signal.

2. The sensor as defined in claim 1, wherein the one of the sensor and temperature characteristics is transmitted as a function of duty cycle of the pulse width modulated signal.

3. The sensor as defined in claim 1, wherein the sensing element comprises a pressure sensor.

4. The sensor as defined in claim 3, wherein the sensor is coupled to a fluid-filled bladder for sensing an occupant in a vehicle.

5. The sensor as defined in claim 1, wherein the temperature sensing circuitry comprises a current mirror that generates a current signal as a function of temperature.

6. The sensor as defined in claim 1, wherein the temperature sensing circuitry comprises first and second current mirrors and a ramp generator for generating a ramp signal, wherein the pulse width modulated output signal is generated as a function of the ramp signal.

7. The sensor as defined in claim 6 further comprising a comparator for comparing the ramp signal to an amplitude of the sensor characteristic.

8. The sensor as defined in claim 8, wherein the ramp signal varies as a function of temperature.

9. The sensor as defined in claim 1, wherein the pulse width modulated output signal is transmitted on a current modulated data bus.

10. A sensor comprising:
a first sensing element for sensing a first characteristic;
a second sensing element for sensing a second characteristic; and
output circuitry for generating a pulse width modulated output signal containing the first and second characteristics, wherein the first characteristic is transmitted as a function of pulse width of the pulse width modulated output signal, and the second characteristic transmitted as a function of frequency of the pulse width modulated output signal.

11. The sensor as defined in claim 10, wherein the first characteristic is provided as a duty cycle of the pulse width modulated output signal.

12. The sensor as defined in claim 10, wherein the first sensing element comprises a pressure sensing element for sensing pressure as the first characteristic.

13. The sensor as defined in claim 10, wherein the second sensing element comprises temperature sensing circuitry for sensing temperature as the second characteristic.

14. The sensor as defined in claim 10, wherein the first sensor comprises a pressure sensor coupled to a fluid-filled bladder for sensing an occupant in a vehicle.

15. The sensor as defined in claim 10, wherein the pulse width modulated output signal is transmitted on a current modulated data bus.

16. A method of transmitting sensor generated output data in a pulse width modulated output signal, said method comprising the steps of:
sensing a sensor characteristic with a sensor;
sensing a temperature characteristic with temperature sensing circuitry;
generating a pulse width modulated output signal containing one of the sensor and temperature characteristics as a function of pulse width of the pulse width modulated output signal, and the other of the sensor and the temperature characteristics as a function of frequency of the pulse width modulated output signal; and
transmitting the pulse width modulated output signal via an output.

17. The method as defined in claim 16, wherein the step of generating a pulse width modulated output signal comprises generating said one of the sensor and temperature characteristics as a function of duty cycle of the pulse width modulated output signal.

18. The method as defined in claim 16, wherein the step of transmitting the pulse width modulated output signal via an output comprises transmitting the pulse width modulated output signal on a current modulated data bus.

19. The method as defined in claim 16, wherein the step of sensing a first characteristic comprises sensing a pressure with a pressure sensor.

20. The method as defined in claim 19, wherein the pressure sensor is coupled to a fluid-filled bladder for sensing an occupant in a vehicle.

21. The method as defined in claim 16, wherein the step of sensing a second characteristic comprises sensing temperature via temperature sensing circuitry.

22. The method as defined in claim 21, wherein the step of sensing temperature comprises a current mirror for generating a current signal as a function of temperature.

23. The method as defined in claim 16 further comprising the step of applying a signal at startup to generate a constant frequency in the pulse width modulated output signal to communicate data in another mode during startup.

24. A method of transmitting sensor generated output data in a pulse width modulated output signal, said method comprising the steps of:
sensing a first characteristic with a sensor;
sensing a second characteristic;
generating a pulse width modulated output signal containing the sensor characteristic as a function of pulse width of the pulse width modulated output signal, and the temperature characteristic as a function of the frequency of the pulse width modulated output signal; and
transmitting the pulse width modulated output signal via an output.

25. The method as defined in claim 24, wherein a step of generating a pulse width modulated output signal comprises generating the output signal to contain the sensor characteristic as a function of duty cycle of- the pulse width modulated output signal.

26. The method as defined in claim 24, wherein the step of sensing a first characteristic comprises sensing pressure with a pressure sensor.

27. The method as defined in claim 26, wherein the pressure sensor is coupled to a fluid-filled bladder for sensing an occupant in a vehicle.

28. The method as defined in claim 27 further comprising the step of processing the output signal to determine if an occupant is present in the vehicle.

29. The method as defined in claim 24, wherein the step of sensing a second characteristic comprises sensing temperature with temperature sensing circuitry.

30. The method as defined in claim 24, wherein the step of transmitting the pulse width modulated output signal comprises transmitting the output signal on a current modulated data bus.

31. The method as defined in claim 24 further comprising the step of applying a signal at startup to generate a constant frequency in the pulse width modulated output signal to communicate data in another mode during startup.
